(19) United States
(12) Patent Application Publication
(10) Pub. No.: US 2017/0334489 A1
(43) Pub. Date: Nov. 23, 2017

(54) FORMING FOR COMPOSITE PANEL FOR IMPARTING STRENGTH

(71) Applicant: Kwang Beom SHIN, San Diego, CA (US)

(72) Inventor: Kwang Beom SHIN, San Diego, CA (US)

(21) Appl. No.: 15/160,228

(22) Filed: May 20, 2016

(51) Int. Cl. B62D 33/04; B32B 7/08; B32B 7/04; B32B 15/01

(52) U.S. Cl. CPC B62D 33/046; B32B 15/016; B32B 7/08; B32B 7/045; B32B 15/011; B32B 2439/00; B32B 2607/00

(57) ABSTRACT

A composite panel for container comprises a first panel portion, first bending portions, a second panel portion, second bending portions, and a rivet joint portion. The first panel portion comprises an outer plate and an inner plate disposed with an even interval therebetween. The first bending portions are provided vertically through the outer plate and the inner plate of the first panel portion. The second panel portion comprises an outer plate and an inner plate disposed with an even interval therebetween. The second bending portions are provided vertically through the outer plate and the inner plate of the second panel portion. The rivet joint portion connects the first panel portion and the second panel portion. The first and second bending portions are configured for imparting structural strength to the composite panel against vibrational or deformational force in a direction perpendicular to the first or second panel portion.

### BACKGROUND OF THE INVENTION

The present invention relates to a forming for composite panel for imparting strength.

Conventional composite panels for container for van trailers including dry container have had a few problems such as generating vibration across the wall of the composite panel due to air friction, dislocating the load to one side of the container so as to increase the dangers of accidents, and limiting its usage to a relatively light load, as shown in FIG. 1.

Sometimes the number of panels were increased to strengthen the structure, but in such a case, the assembling process became difficult to perform and very expensive due to the drastic increase of rivet joint portions, as shown in FIG. 2.

Accordingly, a need for a forming for composite panel for imparting strength has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a forming for composite panel for imparting strength, which can prevent the composite panel from vibrating due to air friction.

Another object of the invention is to provide a forming for composite panel for imparting strength, which is strong enough even without increasing the number of rivet joint portions.

A composite panel for container comprises a first panel portion, one or more first bending portions, a second panel portion, one or more second bending portions, and a rivet joint portion.

The first panel portion comprises an outer plate and an inner plate disposed with an even interval therebetween and having specific height and width.

The one or more first bending portions are provided vertically through the outer plate and the inner plate of the first panel portion.

The second panel portion comprises an outer plate and an inner plate disposed with an even interval therebetween and having specific height and width.

The one or more second bending portions are provided vertically through the outer plate and the inner plate of the second panel portion.

The rivet joint portion connects the first panel portion and the second panel portion.

The one or more first and second bending portions are configured for imparting structural strength to the composite panel against vibrational or deformation force in a direction perpendicular to the first or second panel portion.

The one or more first or second bending portions provided through the outer plate may be aligned with corresponding bending portions provided through the inner plate.

The composite panel may further comprise filling material disposed between the outer plate and the inner plate of the first or second panel portion.

The two neighboring bending portions may define an embossing portion or a protruding portion, and the embossing portion and the protruding portion are disposed next to each other so as to be provided alternatingly horizontally across the first or second panel portion.

The embossing portion may have a same width as the protruding portion.

Each stripe portion connecting the embossing portion and the protruding portion may be perpendicular to the surface of the embossing portion and the protruding portion.

Each stripe portion connecting the embossing portion and the protruding portion may be tilted outwards. The tilting angle may be in a range from about 5 degrees to about 60 degrees with respect to a vertical line to the composite panel.

Alternatively, each each stripe portion connecting the embossing portion and the protruding portion may be tilted inwards. The tilting angle may be in a range from about 5 degrees to about 60 degrees with respect to a vertical line to the composite panel.

The first panel portion may have a width of approximately 1184.3 mm and a height of approximately 2700 mm, and wherein the first panel portion comprises about 15 to 25 first bending portions and about 6 to 12 embossing portions.

Each of the embossing portions may have a bottom width of about 20 mm, each of the protruding portion has a top width of about 75.55 mm, and a horizontal distance from an edge of bottom of the embossing portion to an edge of top neighboring the edge of bottom of the embossing portion is about 8.4 mm, and wherein the even interval between the outer plate and the inner plate is about 6.5 mm.

The advantages of the present invention are: (1) the forming for composite panel according to the invention imparts strength to the composite panel; and (2) the composite panel for imparting strength can be manufactured easily.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a side view showing a trailer with composite panels according to a prior art;

FIG. 2 is another side view showing a trailer with composite panels according to another prior art;

FIG. 3 is a side view showing a trailer with composite panels according to an embodiment of the invention;

FIG. 4 is a top plan view showing an outer plate and an inner plate of a composite panel according to an embodiment of the invention;

FIG. 5 is a front view showing a panel portion according to an embodiment of the invention;

FIG. 6 is another top plan view showing an outer plate and an inner plate of a composite panel according to an embodiment of the invention;

FIG. 7 is a perspective view showing a trailer with composite panels according to an embodiment of the invention; and

FIG. 8 is a top plan view showing two composite panels connected by a rivet joint portion of the wall of the trailer in FIG. 7.

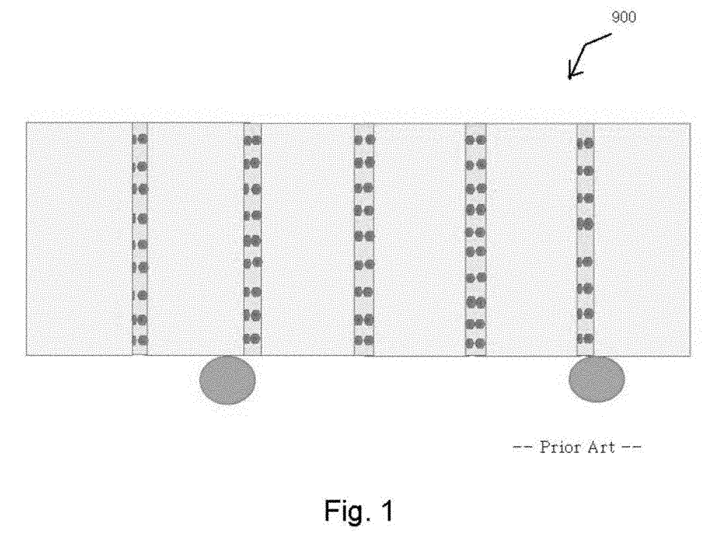

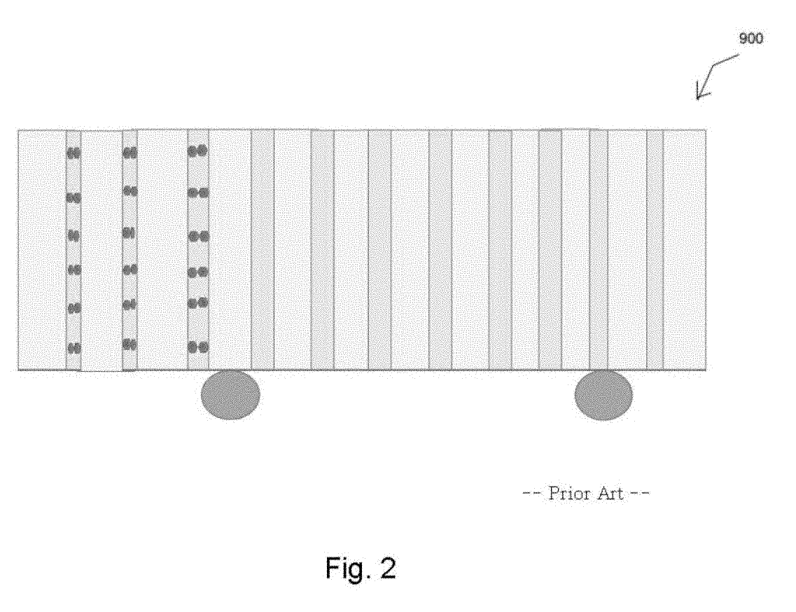

### DETAILED DESCRIPTION EMBODIMENTS OF THE INVENTION

Referring to the figures, the embodiments of the invention are described in detail.

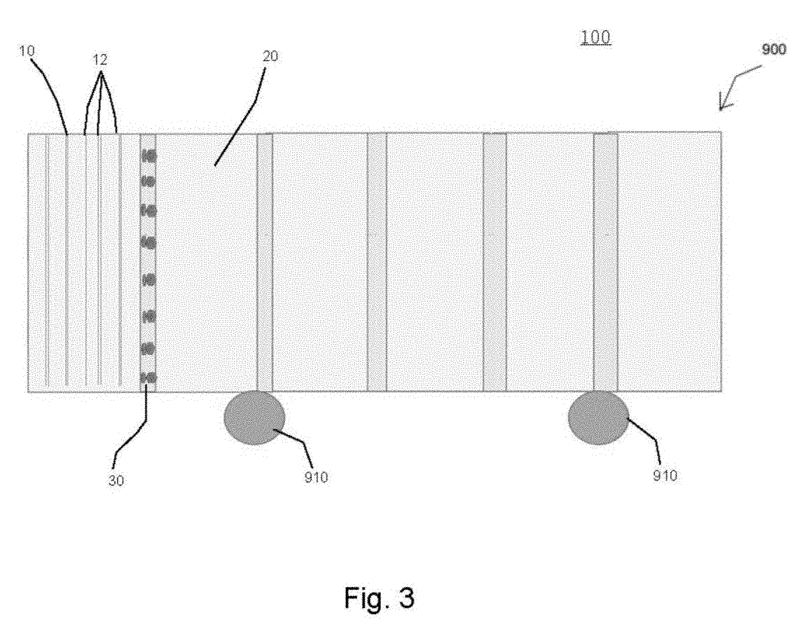

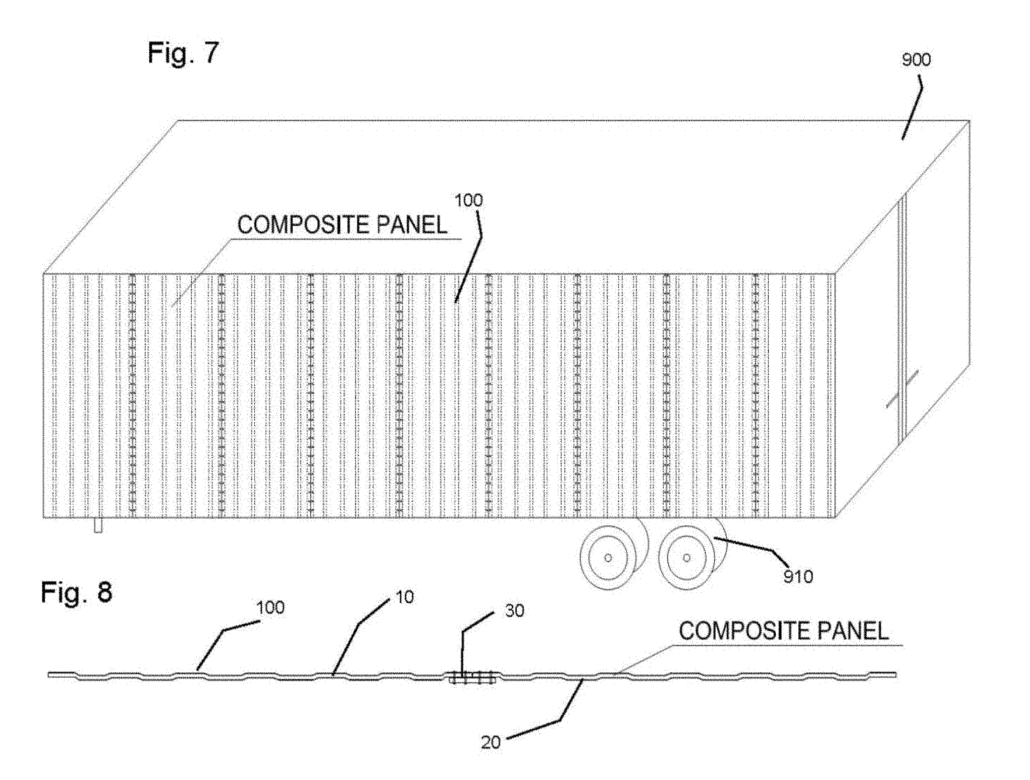

FIGS. 3-8 show a composite panel or a trailer with the composite panel applied.

An object of the invention is to provide a forming for composite panel for imparting strength, which can prevent the composite panel from vibrating due to air friction.

Another object of the invention is to provide a forming for composite panel for imparting strength, which is strong enough even without increasing the number of rivet joint portions.

A composite panel 100 for container 900 with wheels 910 comprises a first panel portion 10, one or more first bending portions 12, a second panel portion 20, one or more second bending portions 22, and a rivet joint portion 30 as shown in FIGS. 3-5.

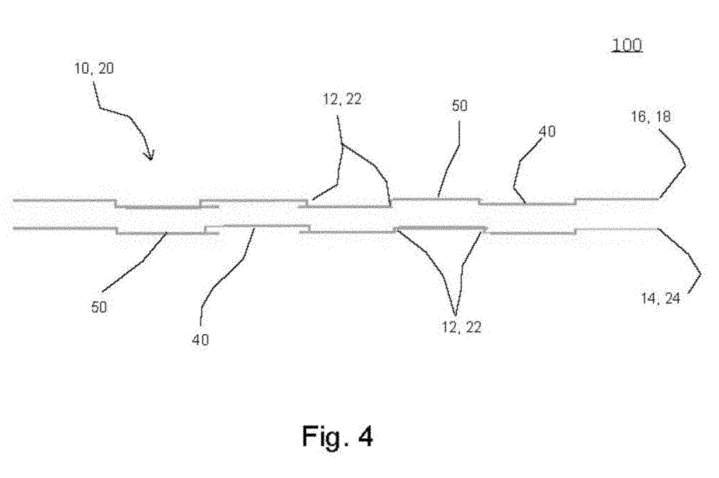

The first panel portion 10 comprises an outer plate 14 and an inner plate 16 disposed with an even interval therebetween and having specific height and width as shown in FIGS. 4, 6, and 7.

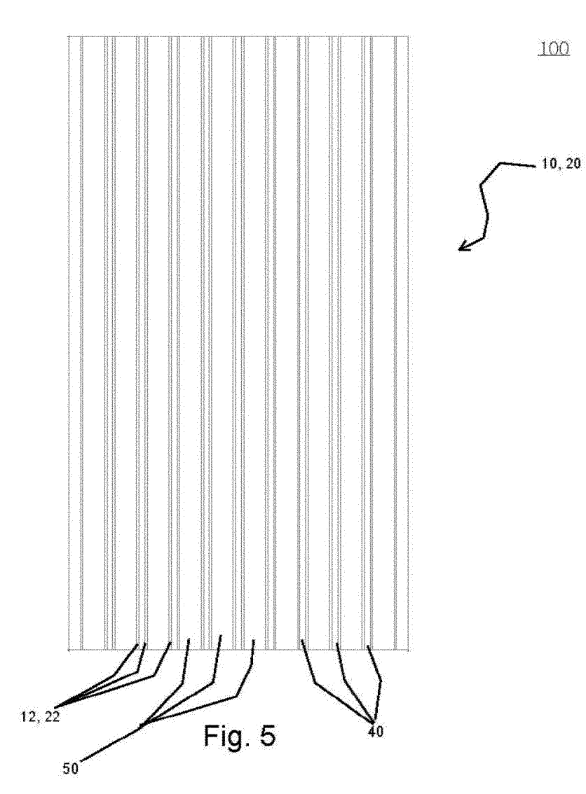

The one or more first bending portions 12 are provided vertically through the outer plate 14 and the inner plate 16 of the first panel portion 10 as shown in FIG. 5.

The second panel portion 20 comprises an outer plate 24 and an inner plate 26 disposed with an even interval therebetween and having specific height and width as shown in FIGS. 4, 6, and 7. Even though the details are omitted for second panel portion 20 in FIG. 3, it has an exactly same structure as the first panel portion 10.

The one or more second bending portions 22 are provided vertically through the outer plate 24 and the inner plate 26 of the second panel portion 20.

The rivet joint portion 30 connects the first panel portion 10 and the second panel portion 20 as shown in FIG. 3.

The one or more first and second bending portions 12, 22 are configured for imparting structural strength to the composite panel 100 against vibrational or deformational force in a direction perpendicular to the first or second panel portion 10, 20 and all across the entire wall of the trailer 900.

The one or more first or second bending portions 12, 22 provided through the outer plate 14, 24 may be aligned with corresponding bending portions 12, 22 provided through the inner plate 16, 26.

The composite panel 100 may further comprise filling material (not shown) disposed between the outer plate 14, 24 and the inner plate 16, 26 of the first or second panel portion 10, 20.

The two neighboring bending portions 12, 22 may define an embossing portion 40 or a protruding portion 50, and the embossing portion 40 and the protruding portion 50 are disposed next to each other so as to be provided alternatingly horizontally across the first or second panel portion 10, 20 as shown in FIGS. 4, 6, and 7.

The embossing portion 40 may have a same width as the protruding portion 50. In certain embodiment of the invention, the embossing portion 40 may have a width shorter than that of the protruding portion 50 as shown in FIGS. 4, 6-8.

Each stripe portion connecting the embossing portion 40 and the protruding portion 50 may be perpendicular to the surface of the embossing portion 40 and the protruding portion 50.

Each stripe portion connecting the embossing portion 40 and the protruding portion 50 may be tilted outwards as shown in FIG. 4, 6-8. The tilting angle may be in a range from about 5 degrees to about 60 degrees, or even larger as long as it gives a needed strength, with respect to a vertical line to the composite panel 100.

Alternatively, each each stripe portion connecting the embossing portion 40 and the protruding portion 50 may be tilted inwards. The tilting angle may be in a range from about 5 degrees to about 60 degrees, again or even larger as long as it gives a needed strength, with respect to a vertical line to the composite panel 100.

The first or second panel portion 10, 20 may have a width of approximately 1184.3 mm and a height of approximately 2700 mm, and wherein the first or second panel portion 10, 20 comprises about 15 to 25 first or second bending portions 12, 22 and about 6 to 12 embossing portions 40 as shown in FIGS. 4, 6, and 7.

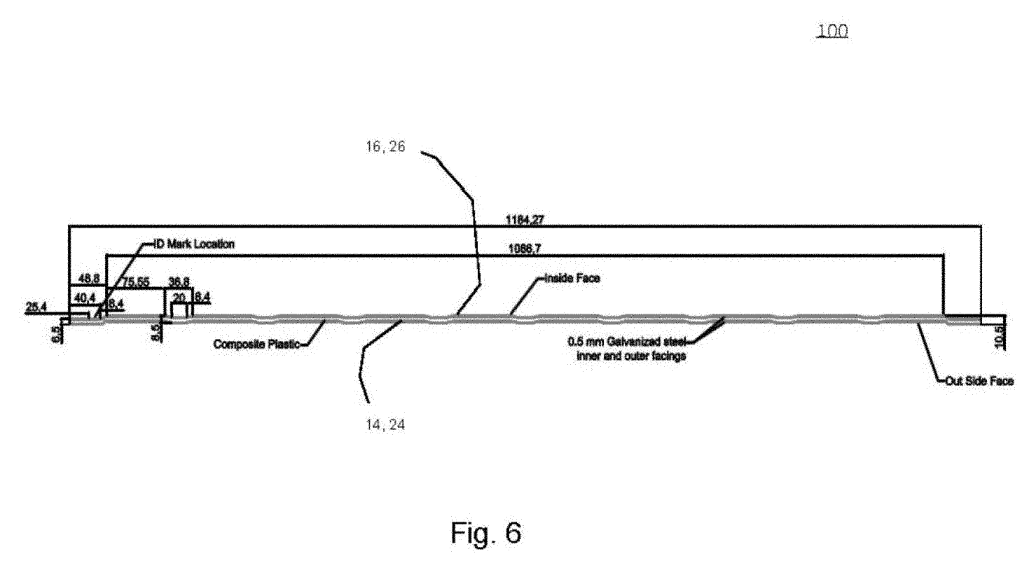

Each of the embossing portions 40 may have a bottom (floor) width of about 20 mm, each of the protruding portion 50 has a top width of about 75.55 mm, and a horizontal distance from an edge of bottom of the embossing portion 40 to an edge of top neighboring the edge of bottom of the embossing portion 40 is about 8.4 mm, and wherein the even interval between the outer plate 14, 24 and the inner plate 16, 26 is about 6.5 mm as shown in FIG. 6. These dimensions are just for an embodiments. Therefore, the detailed dimensions and angles can be varied according to the situation of the problem to solve.

The composite panels according to the present invention can be made of steel or aluminum, and applied to a dry container, a box car, or exterior material in construction.

The forming or bending itself of the above material such as steel or aluminum can be made using a technology known to the community of the art. The forming or bending introduced into the outer plate and the inner plate in such an inventive way according to the invention strengthen the resulting composite drastically.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A composite panel for container, the composite panel comprising:
a first panel portion comprising an outer plate and an inner plate disposed with an even interval therebetween and having specific height and width;
one or more first bending portions provided vertically through the outer plate and the inner plate of the first panel portion;
a second panel portion comprising an outer plate and an inner plate disposed with an even interval therebetween and having specific height and width;
one or more second bending portions provided vertically through the outer plate and the inner plate of the second panel portion; and
a rivet joint portion connecting the first panel portion and the second panel portion,
wherein the one or more first and second bending portions are configured for imparting structural strength to the composite panel against vibrational or deformational force in a direction perpendicular to the first or second panel portion.

2. The composite panel of claim 1, wherein the one or more first or second bending portions provided through the outer plate are aligned with corresponding bending portions provided through the inner plate.

3. The composite panel of claim 2, further comprising filling material disposed between the outer plate and the inner plate of the first or second panel portion.

4. The composite panel of claim 1, wherein two neighboring bending portions define an embossing portion or a protruding portion, wherein the embossing portion and the protruding portion are disposed next to each other so as to be provided alternatingly horizontally across the first or second panel portion.

5. The composite panel of claim 4, wherein the embossing portion has a same width as the protruding portion.

6. The composite panel of claim 4, wherein each stripe portion connecting the embossing portion and the protruding portion is perpendicular to the surface of the embossing portion and the protruding portion.

7. The composite panel of claim 4, wherein each stripe portion connecting the embossing portion and the protruding portion is tilted outwards.

8. The composite panel of claim 7, wherein the tilting angle is in a range from about 5 degrees to about 60 degrees with respect to a vertical line to the composite panel.

9. The composite panel of claim 4, wherein each each stripe portion connecting the embossing portion and the protruding portion is tilted inwards.

10. The composite panel of claim 9, wherein the tilting angle is in a range from about 5 degrees to about 60 degrees with respect to a vertical line to the composite panel.

11. The composite panel of claim 4, wherein the first panel portion has a width of approximately 1184.3 mm and a height of approximately 2700 mm, and wherein the first panel portion comprises about 15 to 25 first bending portions and about 6 to 12 embossing portions.

12. The composite panel of claim 11, wherein each of the embossing portions has a bottom width of about 20 mm, each of the protruding portion has a top width of about 75.55 mm, and a horizontal distance from an edge of bottom of the embossing portion to an edge of top neighboring the edge of bottom of the embossing portion is about 8.4 mm, and wherein the even interval between the outer plate and the inner plate is about 6.5mm.
